(19) United States
(12) Patent Application Publication
(10) Pub. No.: US 2019/0003845 A1
(43) Pub. Date: Jan. 3, 2019

(54) TORNADO WARNING AND AVOIDANCE SYSTEM

(71) Applicant: NPM PROPERTIES, INC., Columbus, GA (US)

(72) Inventor: Patrick H. McKee, Columbus, GA (US)

(21) Appl. No.: 15/980,728

(22) Filed: May 15, 2018

Related U.S. Application Data
(60) Provisional application No. 62/527,950, filed on Jun. 30, 2017.

(51) Int. Cl. G01C 21/34; G01C 21/36; G08B 21/10

(52) U.S. Cl. CPC G01C 21/3461; G08B 21/10; G01C 21/3476; G01C 21/3694

(57) ABSTRACT

Implementations of a tornado warning and avoidance system are provided. In some implementations, the tornado warning and avoidance system comprises a computer implemented method for receiving on a portable computing device a warning of an endangering tornado and an arrival timing of the endangering tornado. In some implementations, the computer implemented method further comprise displaying a selectable display element on the portable computing device for requesting avoidance destination mapping data away from the endangering tornado. In some implementations, in response to selection of the selectable display element, the avoidance destination mapping data is received and displayed on the portable computing device that includes a map showing a route from the user location to the avoidance destination. In some implementations, real-time navigation form the first computing device to the avoidance destination is provided.

### CROSS REFERENCE TO RELATED APPLICATION

This application claims the benefit of U.S. Patent Application Ser. No. 62/527,950, which was filed on Jun. 30, 2017, and is incorporated herein by reference in its entirety.

### TECHNICAL FIELD

This disclosure relates to implementations of a tornado warning and avoidance system.

### BACKGROUND

Tornadoes can cause serious injury or death to persons located in the path of such storms. Systems exist to provide warnings of possible tornado storm activity in the general vicinity of such persons.

However, there does not exist any systems for tracking tornadoes using a mapping system to map an individual out of the path of a tornado using a mobile phone.

### BRIEF DESCRIPTION OF THE DRAWINGS

FIG. 1 illustrates an implementation of an example environment of a tornado warning and avoidance system according to the present disclosure.

FIG. 2 illustrates an example computer system, which may be used with implementations of the present disclosure.

FIG. 3 illustrates an implementation of an example diagram of a danger zone and avoidance destination according to the present disclosure.

FIGS. 4A and 4B illustrate implementations of example user interfaces for displaying notification data and requesting mapping data according to the present disclosure.

FIGS. 5A and 5B illustrate implementations of example user interfaces for displaying mapping data according to the present disclosure.

FIGS. 6A and 6B illustrates implementations of example methods for tornado warning and avoidance according to the present disclosure.

### DETAILED DESCRIPTION

Implementations of a tornado warning and avoidance system are provided. In some implementations, the tornado warning and avoidance system provides a simplified user interface on a portable computing device for warning a user in a danger zone of a potential tornado and an arrival time of the tornado to the user's location. In some implementation, the tornado warning and avoidance system can determine and also navigate the user to a destination away from the danger zone to avoid the tornado. In some implementations, the navigation is provided after a user requests navigation by selecting a request option on the user interface for navigation. In some implementations, the navigation includes an user interface on the portable computing device that includes a map showing a route from the user location to the destination way from the danger zone to avoid the tornado.

In this way, the tornado warning and avoidance system allows a user to get potential life-saving warnings about and navigation away from an approaching tornado.

In some implementations, a computer-implemented method for tornado warning and avoidance is provided. In some implementations, the method comprises receiving storm information at a first computing device. In some implementations, the storm information is transmitted over a network from a second computing device.

In some implementations, the method further comprises receiving a user location at the first computing device. In some implementations, the user location is transmitted over the network from a third computing device.

In some implementations, the method further comprises determining whether the storm information meets one or more predetermined criteria.

In some implementations, the method further comprises determining at the first computing device a danger zone of the endangering tornado.

In some implementations, the method further comprises determining an arrival time of the storm to the user location.

In some implementations, the method further comprises determining at the first computing device an avoidance destination outside the danger zone.

In some implementations, the method further comprises when the storm information meets the one or more predetermined criteria and the user location is determined to be within the danger zone of the endangering tornado, transmitting at the first computing device the avoidance destination and notification data to the third computing device. In some implementations, the notification data comprises data indicating an approaching storm and an arrival time of the endangering tornado to the user location.

In some implementations, the method further comprises receiving and displaying the notification data at the third computing device.

In some implementations, the method further comprises displaying at the third computing device a selectable display element for a user to request mapping data from the location of the third computing device to the avoidance destination.

In some implementations, the method further comprises receiving at the third computing device, in response to selection of the selectable display element, the mapping data from the location of the third computing device to the avoidance destination.

In some implementations, the method further comprises displaying at the third computing device a map showing a route from the location of the third computing device to the avoidance destination.

In some implementations, the method further comprises providing real-time navigation from the third computing device to the avoidance destination.

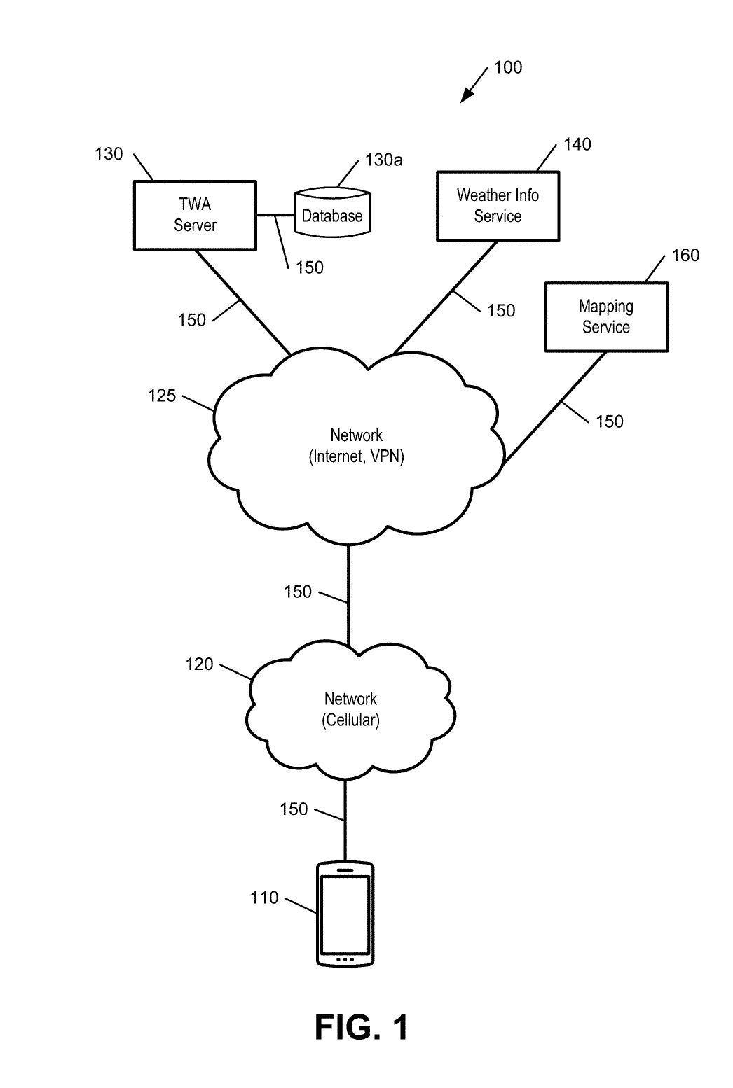

FIG. 1 illustrates an implementation of an example environment 100 of a tornado warning and avoidance system according to the present disclosure.

As shown in FIG. 1, in some implementations, the environment 100 may include one or more client devices 110, a wireless cellular network 120, a network 125, and one or more servers 130, and one or more weather information service servers 140. In some implementations, the example tornado warning and avoidance system environment 100 also may include one or more data storage 130a linked to one or more servers 130.

In some implementations, the tornado warning and avoidance server 130 is configured to poll a weather information service server 140 for weather information. In some implementations, the tornado warning and avoidance server 130 is configured to poll the weather information service server 140 for storm information. In some implementation, the storm information may include, for each storm, a heading or direction of the storm, a starting point (e.g., starting coordinates) of the storm, the velocity of the storm, the type of the storm, the likelihood that the storm will turn into a tornado, dual polarization information, information to determine if the storm is a tornado, information to determine if the storm is on the ground, information to determine the amount of debris in the atmosphere, a Baron Tornado Index (BTI), any other relevant storm information, or any combination of the foregoing. In some implementations, the weather information service server 140 is a third party weather information server.

In some implementations, the tornado warning and avoidance server 130 is configured to poll the weather information service server 140 on a periodic basis. In some implementations, the periodic basis is every two minutes. In some implementations, the periodic basis is less than every two minutes. In some implementations, the periodic basis is greater than every two minutes. In some implementations, the periodic basis is any other suitable period.

In some implementations, the tornado warning and avoidance server 130 is configured to store the storm information from the weather information service at data storage 130a.

In some implementations, the tornado warning and avoidance server 130 is configured to receive and store (e.g., at data storage 130a) location information from client devices 110.

In some implementations, each time the tornado warning and avoidance server 130 polls the weather information service server 140 and/or receives storm information from the weather information service server 140, the tornado warning and avoidance server 130 is configured to determine any endangered users among the users of client devices 110 for which location information is received.

In some implementations, once an endangered user is determined, the tornado warning and avoidance server 130 is configured to send one or more notifications to the client device 110 of the endangered user to alert the user of a potential tornado. In some implementations, the notification also includes a calculated arrival time of the tornado to the location of the client device 110. In some implementations, the tornado warning and avoidance server 130 is configured to deliver notifications through an Android and iOS device message-push facilitator such as Google Firebase. In some implementations, the tornado warning and avoidance server 130 is configured to deliver notifications through any other suitable service.

In some implementation, the tornado warning and avoidance server 130 is configured to determine a destination to avoid the tornado (“avoidance destination”). In some implementation, the tornado warning and avoidance system is configured to enable the user's client device 110, is navigate the user from the location of the client device to the avoidance destination.

In some implementations, the tornado warning and avoidance server 130 is configured to determine that a user of a client device 110 is endangered (“endangered user”) if the storm information received from the weather information service server 140 meets one or more predetermined criteria and/or if the client device 110 of the user is located in a calculated danger zone of the storm.

In some implementations, the predetermined criteria for the storm information received from the weather information service server 140 include the storm information indicating that a storm is a tornado or has a possibility of becoming a tornado. For example, in some implementations, the predetermined criteria for the storm information received from the weather information service server 140 include storm information indicating a storm having a type of “tornado high possibility” or “tornado low possibility” as defined by Baron Services, Inc. In this way, in some implementations, the tornado warning and avoidance system does not send alerts for high winds or storms that are not tornadoes, for example. In this way, in some implementations, the predetermined criteria for the storm information received from the weather information service server 140 include storm information indicating that a storm is high winds.

In some implementations, the predetermined criteria for the storm information received from the weather information service server 140 include storm information indicating a storm having a likelihood of turning into a tornado greater than a predetermined value. For example, in some implementations, the predetermined criteria include storm information indicating a storm having a Baron Tornado Index (BTI) greater than a predetermined value. In some implementations, the predetermined criteria include storm information indicating a storm having a BTI greater than or equal to 5.

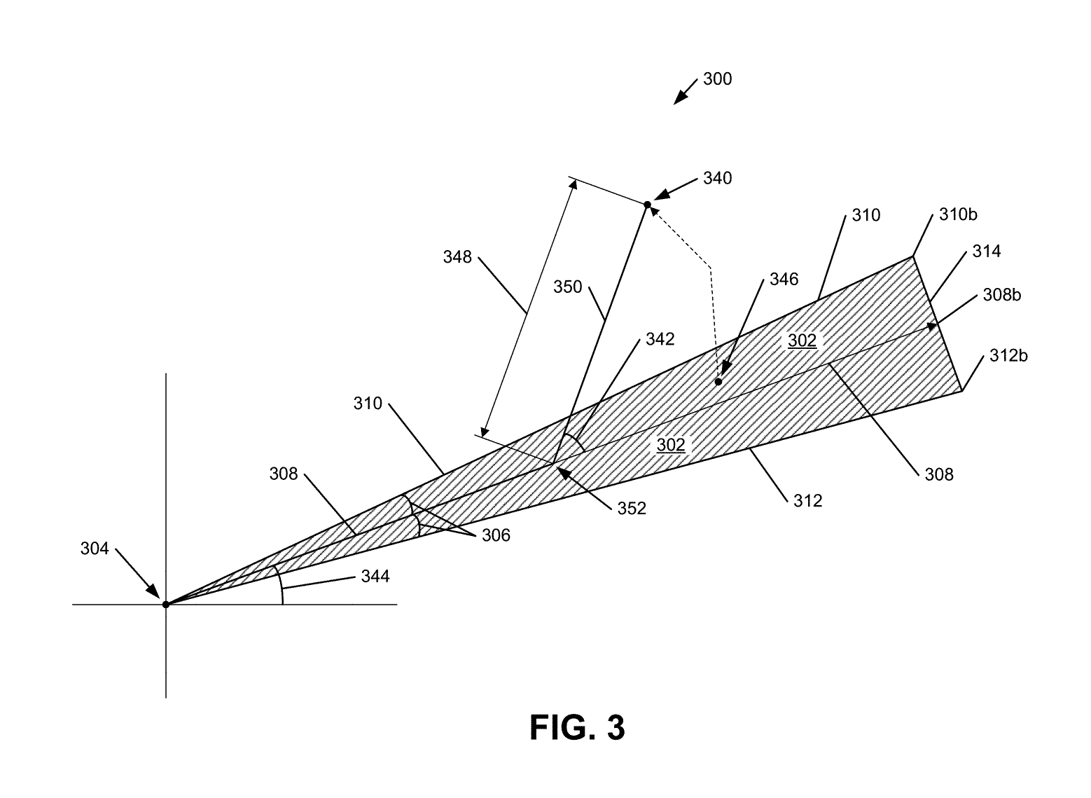

FIG. 3 illustrates an example diagram 300 of a danger zone 302 of an endangering tornado (i.e., a storm that meets the predetermined criteria as discussed above) and avoidance destination 340 that may be calculated by the tornado warning and avoidance server 130. In some implementations, the tornado warning and avoidance server 130 determines the danger zone 302 based on a current location 304 of the endangering tornado, a heading vector (direction of motion) 308 of the endangering tornado, and a travel speed of the endangering tornado received by the weather information service server 140.

In some implementations, the danger zone 302 may be any location within a zone defined by the heading vector 308 of the endangering tornado and edge vectors 310, 312. In some implementations, the danger zone 302 may also include any locations on the edge vectors 310, 312. In some implementations, the heading vector 308 and edge vectors 310, 312 start at the current location 304 of the endangering tornado and, for each vector, ends where the vector meets a far side vector 314 (discussed below).

In some implementation, the edge vectors 310, 312 may be vectors a predetermined number of degrees (the “danger zone angle 306”) to the left and right, respectively, of the heading vector 308.

In some implementations, the length of the edge vectors 310, 312 may be based on the travel distance of the endangering tornado within a predetermined time. In some implementations, the length of the edge vectors 310, 312 may be calculated by multiplying the speed of the endangering tornado and a predetermined time. In some implementations, the predetermined time is 30 minutes. In some implementations, the predetermined time is less than 30 minutes. In some implementations, the predetermined time is greater than 30 minutes. In some implementations, the predetermined time is any suitable time.

In some implementations, the danger zone angle 306 is five degrees. In some implementations, the danger zone angle 306 is less than five degrees. In some implementations, the danger zone angle 306 is greater than five degrees. In some implementations, the danger zone angle 306 is any other suitable size.

In some implementations, the danger zone 302 can have any other suitable width and configuration.

In some implementations, the danger zone 302 is bounded by a far side vector 314 that extends from the distal end 310b of the edge vectors 310 and to the distal end 312b of the edge vectors 312.

As discussed above, if a user is located in a calculated danger zone of a storm (e.g., location 346), the tornado warning and avoidance server 130 is configured to send one or more notifications to the client device 110 of the endangered user to alert the user of a potential tornado and a calculated arrival time of the tornado to the location of the client device 110.

In some implementations, the storm arrival time is determined by computing the distance between the storm and the client device 110 of the endangered user and dividing the distance by the storm velocity. In some implementations, the computed time is added to the current time to determine the time of arrival. In some implementations, the computed time is a computed time remaining until the arrival of the storm to the user's location.

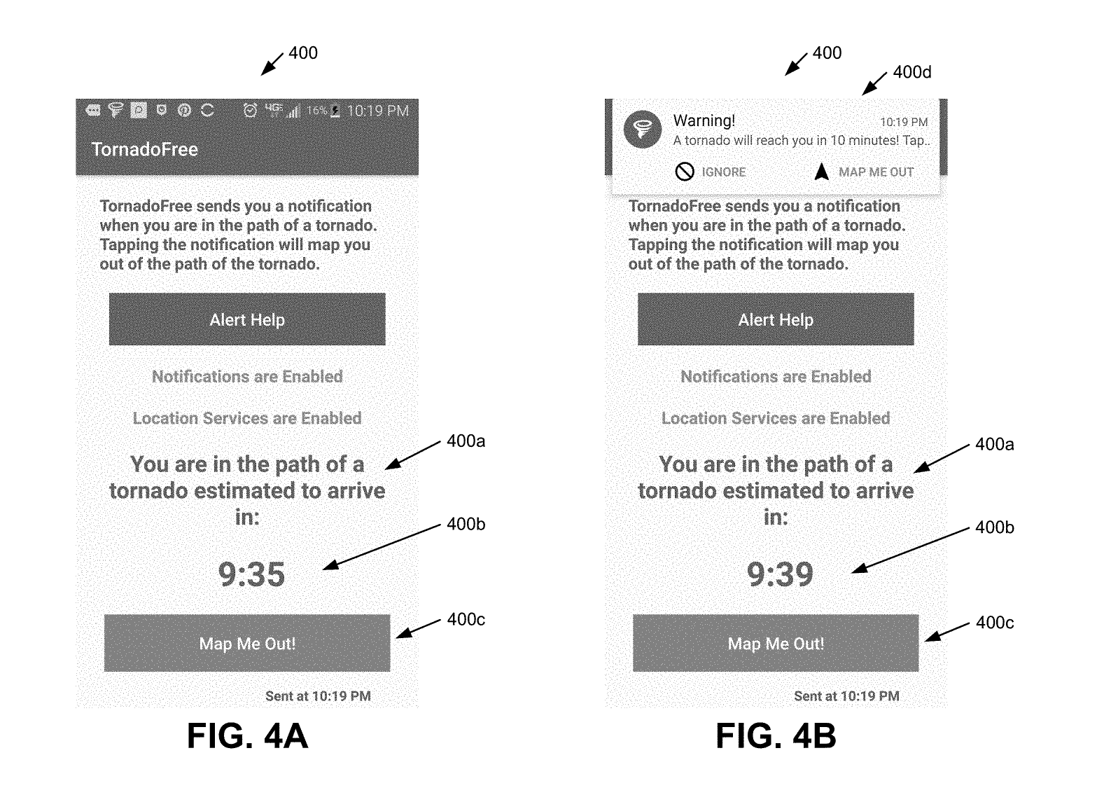

FIGS. 4A and 4B illustrate implementations of example user interfaces 400 for alerting an endangered user of the potential tornado and a calculated arrival time of the tornado to the endangered user's client device 110. In some implementations, the user interface 400 may be displayed on a client device 110 when the client device location 110 is determined to be within the danger zone of an approaching endangering tornado.

In some implementations, the user interface 400 comprises a display element 400a of a warning of the endangering tornado. In implementations, the display element 400a is text. In some implementations, the display element 400a is graphics. In some implementations, the display element 400a is a combination of text and graphics. In some implementations, the display element 400a is any suitable display.

In some implementations, the user interface 400 also comprises a display element 400b indicating an arrival time of the endangering tornado. In some implementations, the tornado warning and avoidance system is configured such that arrival time display element 400b updates (e.g., counts down) as the endangering tornado approaches.

In some implementations, the user interface 400 also comprises a selectable display element 400c for a user to request mapping data to an avoidance destination away from the endangering tornado.

In some implementations, as shown in FIG. 4B, the user interface 400 comprises a banner notification 400d. In some implementations, the banner notification 400d also comprises the warning of the approaching endangering tornado. In some implementations, the banner notification 400d also comprises a selectable display element to request mapping data to an avoidance destination away from the endangering tornado.

Returning to FIG. 3, in some implementations, the tornado warning and avoidance system determines the avoidance destination 340 based on the heading vector 308 of the endangering tornado and the location 346 of the client device 110.

In some implementations, the avoidance destination 340 is to the left of the danger zone 302 if the user is located to the left of the heading vector 308. In some implementations, the avoidance destination 340 is to the right of the danger zone 302 if the user is located to the right of the heading vector 308.

In some implementation, the avoidance destination 340 is determined by an avoidance vector 350 extending from the heading vector 308 at a predetermined angle (“an avoidance angle 342:) from a predetermined location (“an avoidance starting point 352”) on the heading vector 308 for a predetermined distance (“the avoidance distance 348”).

In some implementations, the avoidance angle 342 is added to the heading vector angle 344 if the client device 110 is located 346 on the left side of the storm danger zone 302 (e.g., if the client device 110 is closer to the left edge vector 310 of the danger zone 302 then to the right edge vector 312). In some implementations, the avoidance angle 342 is subtracted from the heading vector angle 344 if the user is located 346 on the right side of the storm danger zone 302 (e.g., if the user is closer to the right edge vector 312 of the danger zone 302 then to the left edge vector 310).

In some implementations, the avoidance angle 342 is fifty degrees. In some implementations, the avoidance angle 342 is less than fifty degrees. In some implementations, the avoidance angle 342 is greater than fifty degrees. In some implementations, the avoidance angle 342 is any other suitable size.

In some implementations, the avoidance distance 348 is five miles. In some implementations, the avoidance distance 348 is less than miles. In some implementations, the avoidance distance 348 is greater than five miles. In some implementations, the avoidance distance 348 is any other suitable distance.

In some implementations, the avoidance starting point 352 is a point (e.g., defined by coordinates) halfway along the heading vector 308 defined by the start point 304 and end point 308b. In some implementations, the avoidance starting point 352 is a point less than halfway along the heading vector 308 defined by the start point 304 and end point 308b. In some implementations, the avoidance starting point 352 is a point greater than halfway along the heading vector 308 defined by the start point 304 and end point 308b. In some implementations, the avoidance starting point 352 is any suitable point along the heading vector 308.

In some implementations, the avoidance destination 340 is a location determined as described above that is on the nearest roadway. In some implementations, the avoidance destination 340 is any other suitable location determined as described above.

In some implementations, the avoidance destination (e.g., destination 340) is provided to the client device 110 of the endangered user and the tornado warning and avoidance system is configured to display the avoidance destination to the user on a display of the client device 110. In some implementation, the avoidance destination is displayed on a map on the client device 110. In some implementations, the tornado warning and avoidance system is configured to provide one or more routes from the user's location 346 to the avoidance destination. In some implementations, a route from the user's location 346 to the avoidance destination is shown on a map. In some implementation, the tornado warning and avoidance system is configured to navigate the user from the user's location 346 to the avoidance destination in real-time. In some implementation, the tornado warning and avoidance system provides voice commands to navigate the user from the user's location 346 to the avoidance destination in real-time.

In some implementations, the tornado warning and avoidance system is configured to provide the avoidance destination to a real-time GPS navigation application on client device 110 such as using Google Maps or other similar applications to communicate with a mapping service 160 to display the avoidance destination and provide navigation from the user's current location to the avoidance destination.

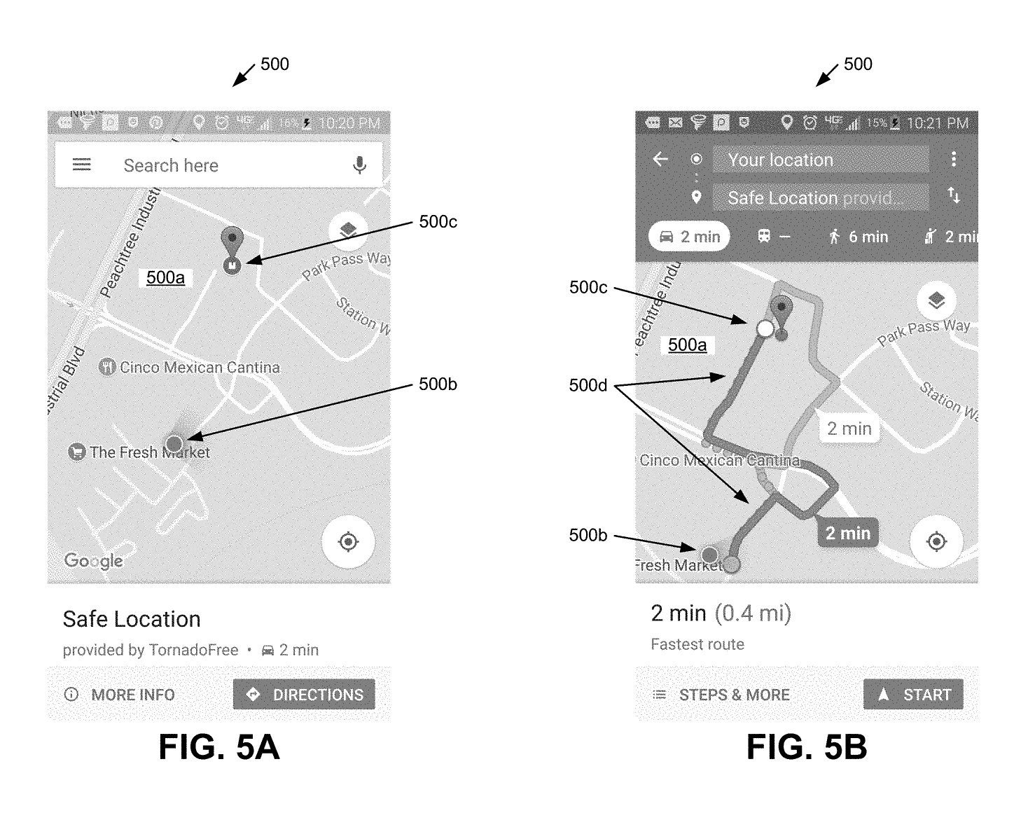

FIGS. 5A and 5B illustrate implementations of example user interfaces 500 for displaying on a map 500a an avoidance destination 500c and a route from the user's client device location 500b to the avoidance destination 500c according to the present disclosure. In some implementations, as shown in FIG. 5B, a route 500d is displayed on the map 500a from the user's client device location 500b to the avoidance destination 500c.

In some implementations, the user interface 500 is displayed on a client device 110 in response to a request for mapping data (e.g., in response to a selection of the selectable display element 400c of the user interface 400) to an avoidance destination away from the endangering tornado after the client device 110 receives an alert of a potential tornado.

In some implementations, the avoidance destination is displayed on the client device as a text description such as an address, street intersection, or other location information. In some implementations, the avoidance destination is provided to the user in any other suitable form.

The client device 110 is depicted as a mobile phone, but the client device 110 may comprise any type of portable computing device, such as a laptop, cellular phone, a smart device, a mobile telephone, a tablet-style computer, or any other handheld electronic device capable of wireless communication. In some implementations, the client device 110 is configured to interact with the server device 130 via an application, such as a native application, residing on the client device 110.

In some implementations, the client devices 100 include hardware, software, or embedded logic components or a combination of two or more such components and are configured to carry out the appropriate functions implemented or supported by the client devices 110.

In some implementations, each of the client devices 110 may include one or more processors, one or more memories, one or more displays, one or more interfaces, one or more components capable of inputting data, one or more components capable of outputting data, one or more components capable of communicating with any other component of the environment 100 of the tornado warning and avoidance system, or any other component suitable for a particular purpose.

In some implementations, the client devices 110 are configured to access networks 120 and/or 125. In some implementations, the client devices 110 are configured to communicate with servers 130, 160.

In some implementations, a client device 110 can connect to the network 125 through a wireless cellular network 120, such as GPRS-based and CDMA-based wireless networks, as well as 802.16 WiMax and long-range wireless data networks.

In some implementations, components of the tornado warning and avoidance system environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some implementations, components of the tornado warning and avoidance system environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server devices 130, 140 160 may include a processor, memory, user accounts, and one or more modules to perform various functions.

In some implementations, each server 130, 140, 160 may be a unitary server or may be a distributed server spanning multiple computers or multiple datacenters. Servers 130, 140, 160 may be of various types, such as, for example and without limitation, web server, file server, application server, exchange server, database server, or proxy server. In some implementations, each server 130, 140, 160 may include hardware, software, or embedded logic components or a combination of two or more such components for carrying out the appropriate functionalities implemented or supported by server 130, 140, 160. For example, a web server is generally capable of hosting websites containing web pages or particular elements of web pages. More specifically, a web server may host HTML files or other file types, or may dynamically create or constitute files upon a request, and communicate them to clients 110 in response to HTTP or other requests from clients 110. A database server is generally capable of providing an interface for managing data stored in one or more data stores.

In some implementations, one or more data storages 130a may be communicatively linked to one or more servers 130 via one or more links 150. In some implementations, data storages 130a may be used to store various types of information (e.g., storm information, client device location information, danger zone, avoidance destination, arrival time, etc.). In some implementations, the information stored in data storages 130a may be organized according to specific data structures. In particular embodiment, each data storage 130a may be a relational database. Particular embodiments may provide interfaces that enable servers 130, 140 or clients 110 to manage, e.g., retrieve, modify, add, or delete, the information stored in data storage 130a.

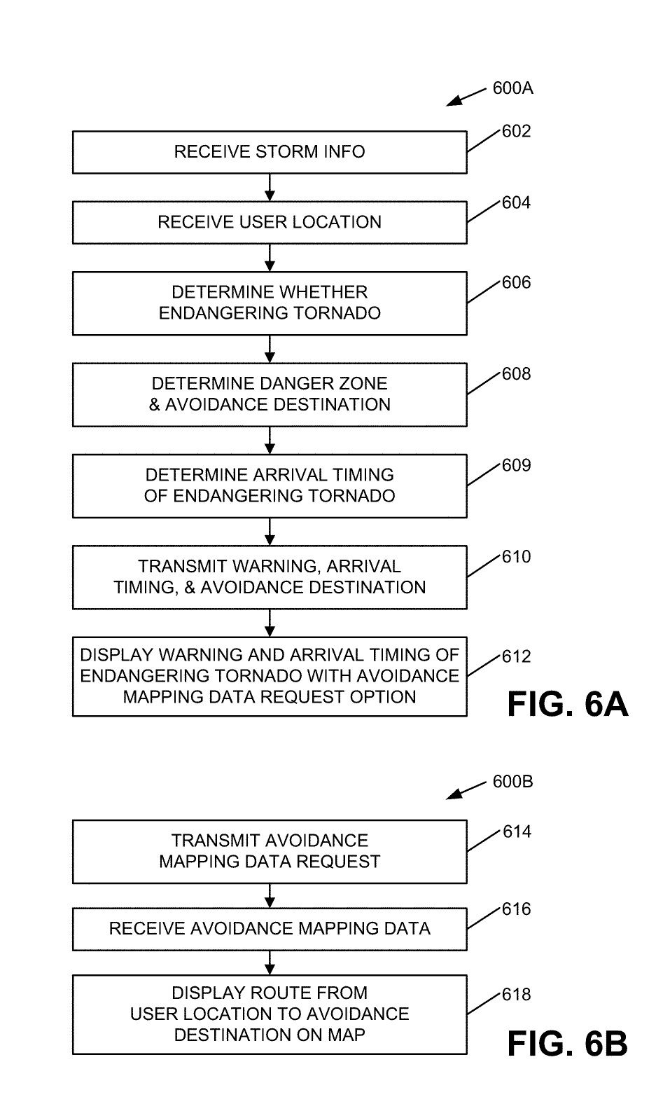

FIGS. 6A and 6B illustrate implementations of example methods 600A, F, respectively, for tornado warning and avoidance in the environment of FIG. 1 according to the present disclosure.

Referring to FIG. 6A, in some implementations, the method 600A comprises receiving 602 storm information at a server 130. In some implementations, the storm information is transmitted over a link 150 and/or a network 125 from a weather information service server 140. In some implementations, the storm information is stored at the data storage 130a.

In some implementations, the method 600A further comprises receiving 604 a user location at the tornado warning and avoidance server 130. In some implementations, the user location is transmitted over a link 150, network 120, and/or network 125 or any combination of the foregoing from a client device 110. In some implementations, the user location is stored at the data storage 130a.

In some implementations, the method 600A further comprises determining 606 (e.g., at the tornado warning and avoidance server 130) whether the storm information meets one or more predetermined criteria to qualify as an endangering tornado.

In some implementations, the method 600A further comprises when the storm information meets one or more predetermined criteria, determining 608 (e.g., at the tornado warning and avoidance server 130) a danger zone of the endangering tornado. In some implementations, an avoidance destination also is determined.

In some implementations, the method 600A further comprises determining 609 the arrival time of the endangering tornado to any client device 110 in the danger zone.

In some implementations, the method 600A further comprises transmitting 610 at the tornado warning and avoidance server 130 notification data to any client device 110 in the danger zone. In some implementations, the notification data comprises a notification of the endangering tornado and the arrival time of the endangering tornado to the client device 110. In some implementations, an avoidance destination also is transmitted.

In some implementations, the method 600A further comprises displaying 612 the alert and the arrival timing of the endangering tornado on a first user interface at a client device 110. In some implementations, the first user interface also comprises a selectable display element to request mapping data to an avoidance destination away from the endangering tornado.

In some implementations, the method 600A further comprises sounding a warning alert sound at the client 110 in the danger zone.

Referring to FIG. 6B, in some implementations, the method 600B comprises when the selectable display element to request mapping data to the avoidance destination is activated by a user, transmitting 614 at the client device 110 a request to a mapping service (e.g., mapping service 130, 160) for mapping data to the avoidance destination.

In some implementations, the method 600B further comprises receiving 616 at the client device 110 the mapping data to the avoidance destination

In some implementations, the method 600B further comprises displaying 618 a second user interface at the portable computing device 110. In some implementations, the second user interface comprises a map showing a route from the user location to the avoidance destination.

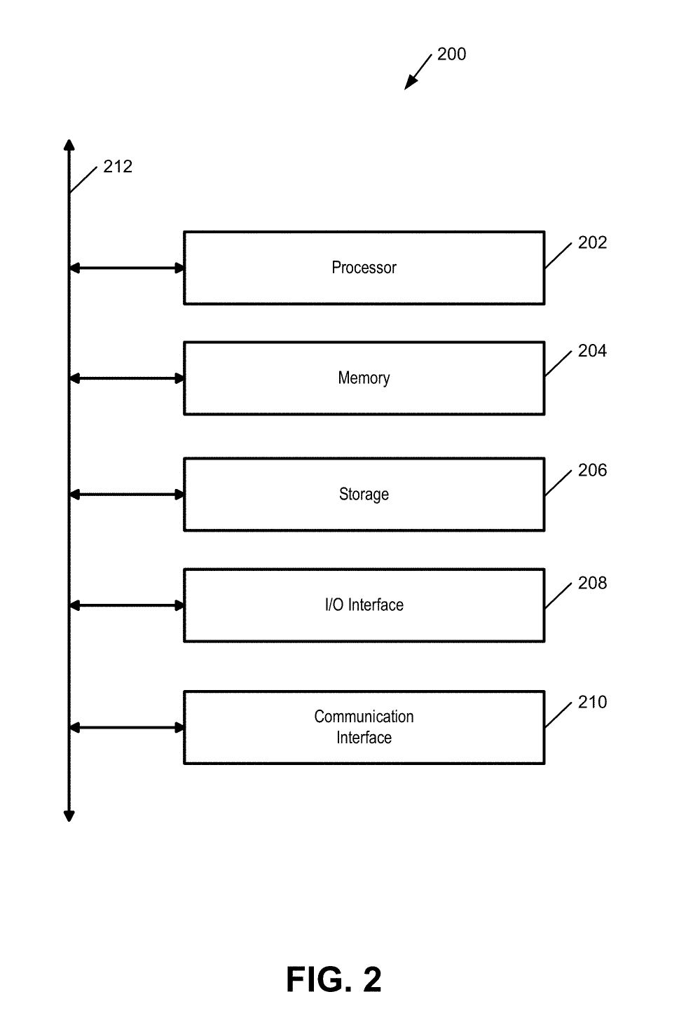

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on email, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

1. A computer-implemented method for tornado warning and avoidance, the method comprising:
receiving storm information for a storm at a first computing device wherein the storm information is transmitted over a network from a second computing device;
receiving a user location at the first computing device wherein the user location is transmitted over a network from a third computing device and the user location is the location of the third computing device;
determining at the first computing device whether the storm information meets one or more predetermined criteria;
determining at the first computing device a danger zone of the endangering tornado;
determining an arrival time of the storm to the user location;
determining at the first computing device an avoidance destination outside the danger zone; and
transmitting at the first computing device, when the storm information meets the one or more predetermined criteria and the user location is determined to be within the danger zone, the avoidance destination and notification data to the third computing device over a network, wherein the notification data comprises data indicating an approaching storm and the arrival time of the storm to the user location.

2. The computer-implemented method of claim 1 wherein the storm information comprises a direction of the storm, a location of the storm, and a velocity of the storm and wherein the danger zone comprises locations within a zone defined by a left side vector extending from the location of the storm a first length to a first point and a second side vector extending from location of the storm a second length to a second point and a far side vector that extends from the first point to the second point,
wherein the left side vector is a predetermined number of degrees to the left of the direction of the storm and the right side vector is a predetermined number of degrees to the right of the direction of the storm; and
wherein the first and second length is based on the travel distance of the storm within a predetermined time.

3. The computer-implemented method of claim 2 wherein the one or more predetermined criteria comprises the storm information indicating that the storm is a tornado or has a possibility of becoming a tornado.

4. The computer-implemented method of claim 2 wherein the avoidance destination is defined by an avoidance vector extending from a heading vector at a predetermined avoidance starting point, in a predefined avoidance angle, for a predetermined avoidance distance ending at the avoidance destination, wherein the heading vector is defined by the direction of the storm and extends from the location of the storm and intersects the far side vector at a third point.

5. The computer-implemented method of claim 2 wherein the arrival time is a distance between the location of the storm and the location of the third computing device divided by the velocity of the storm.

6. A computer-implemented method for tornado warning and avoidance, the method comprising:
receiving notification data at a first computing device wherein the notification data is transmitted over a network from a second computing device and wherein the notification data comprises data indicating an approaching storm and the arrival time of the storm to the first computing device;
receiving an avoidance destination at the first computing device wherein the avoidance destination is outside a determined danger zone and wherein the avoidance destination is transmitted over a network from the second computing device;
displaying the notification data at the first computing device;
displaying at the first computing device a selectable display element for a user to request mapping data from the location of the first computing device to the avoidance destination;
receiving at the first computing device, in response to selection of the selectable display element, the mapping data from the location of the first computing device to the avoidance destination;
displaying at the first computing device the mapping data; and
providing real-time navigation from the first computing device to the avoidance destination.

7. A computer-implemented method of claim 6 wherein displaying at the first computing device the mapping data comprises displaying a map showing a route from the location of the first computing device to the avoidance destination.

8. The computer-implemented method of claim 7 wherein displaying at the first computing device the mapping data comprises displaying comprises displaying driving directions from the location of the first computing device to the avoidance destination.

9. A computer-implemented method for tornado warning and avoidance, the method comprising:
receiving storm information for a storm at a first computing device wherein the storm information is transmitted over a network from a second computing device;
receiving a user location at the first computing device wherein the user location is transmitted over a network from a third computing device and the user location is the location of the third computing device;
determining at the first computing device whether the storm information meets one or more predetermined criteria;
determining at the first computing device a danger zone of the endangering tornado;
determining an arrival time of the storm to the user location wherein the arrival time is a distance between the location of the storm and the location of the third computing device divided by the velocity of the storm;
determining at the first computing device an avoidance destination outside the danger zone; and
transmitting at the first computing device, when the storm information meets the one or more predetermined criteria and the user location is determined to be within the danger zone, the avoidance destination and notification data to the third computing device over a network, wherein the notification data comprises data indicating an approaching storm and the arrival time of the storm to the user location,
receiving and displaying the notification data at the third computing device;
displaying at the third computing device a selectable display element for a user to request mapping data from the location of the third computing device to the avoidance destination;
receiving at the third computing device, in response to selection of the selectable display element, the mapping data from the location of the third computing device to the avoidance destination;
displaying at the third computing device a map showing a route from the location of the third computing device to the avoidance destination; and
providing real-time navigation from the third computing device to the avoidance destination,
wherein the storm information comprises a direction of the storm, a location of the storm, and a velocity of the storm and wherein the danger zone comprises locations within a zone defined by a left side vector extending from the location of the storm a first length to a first point and a second side vector extending from location of the storm a second length to a second point and a far side vector that extends from the first point to the second point,
wherein the left side vector is a predetermined number of degrees to the left of the direction of the storm and the right side vector is a predetermined number of degrees to the right of the direction of the storm;
wherein the first and second length is based on the travel distance of the storm within a predetermined time;
wherein the one or more predetermined criteria comprises the storm information indicating that the storm is a tornado or has a possibility of becoming a tornado; and
wherein the avoidance destination is defined by an avoidance vector extending from a heading vector at a predetermined avoidance starting point, in a predefined avoidance angle, for a predetermined avoidance distance ending at the avoidance destination, wherein the heading vector is defined by the direction of the storm and extends from the location of the storm and intersects the far side vector at a third point;
